(19) United States
(12) Patent Application Publication
(10) Pub. No.: US 2012/0124599 A1
(43) Pub. Date: May 17, 2012

(54) OPTICAL DISK DRIVE EJECTION

(76) Inventors: Robin T. Lovelace, Tomball, TX (US); Qijun Chen, Spring, TX (US); Lee Atkinson, Houston, TX (US)

(21) Appl. No.: 13/384,752

(22) PCT Filed: Jan. 29, 2010
(86) PCT No.: PCT/US10/22577

§ 371 Date: Jan. 18, 2012

(51) Int. Cl. G11B 17/04

(52) U.S. Cl. 720/601; G9B/17.013

(57) ABSTRACT

A host computer is connected to an optical disk drive via an interface. An optical disk drive eject switch located on the host computer triggers a media ejection mechanism on the optical disk drive.

### BACKGROUND

Computers (e.g., desktops, notebooks, etc.) commonly include an optical disk drive that reads optical media. Optical disk drives are connected to the host computer via an interface. One type of interface used to connect an optical disk drive (ODD) to a host computer is a serial ATA, or SATA, bus.

### BRIEF DESCRIPTION OF DRAWINGS

The following description includes discussion of figures having illustrations given by way of example of implementations of embodiments of the invention.

FIG. 1 is a block diagram illustrating a system according to various embodiments.

FIG. 2 is a block diagram illustrating a system according to various embodiments.

FIG. 3 is a flow diagram of operation in a system according to various embodiments.

FIG. 4 is a flow diagram of operation in a system according to various embodiments.

### DETAILED DESCRIPTION

Many optical disk drives, or ODDs, including tray-loading ODDs, eject media either by issuing a software eject command to the ODD or by use of an electrical eject switch on the ODD itself that serves as an internal drive notification of an eject request by a user. In systems that use a SATA (serial advanced technology attachment) bus, power consumption by the ODD can be managed via an interface power management (IPM) or similar protocol; however, power conservation is often limited given that SATA link detection circuitry remains active to preserve the ability to communicate with the host computer in response to an eject request. To maintain the active SATA link, a minimum (non-zero) power usage quantity is specified for the system.

In contrast to the systems described above, various embodiments described herein achieve power consumption savings by placing an optical disk drive (ODD) eject switch on the host computer as opposed to putting it directly on the ODD itself. In certain embodiments, when a user enables the ODD eject switch on the host computer, the switch drives an electrical signal to ground. If power is enabled to the ODD and the SATA bus is active, then grounding of the electrical switch (e.g., by a user's enablement of the switch) is passed directly to the ODD via the SATA bus. In various embodiments, the grounding signal is passed to the ODD via a single pin on the SATA bus. The signal passed to the ODD notifies the ODD to eject media (e.g., eject the ODD tray).

If power to the ODD is disabled and/or the SATA bus is not active when the ODD eject switch is enabled, the grounding of the ODD eject switch notifies the host computer that an ODD media eject request has been made. In response, the host computer enables power to the ODD and issues a command to the ODD to eject media (e.g., via the eject tray).

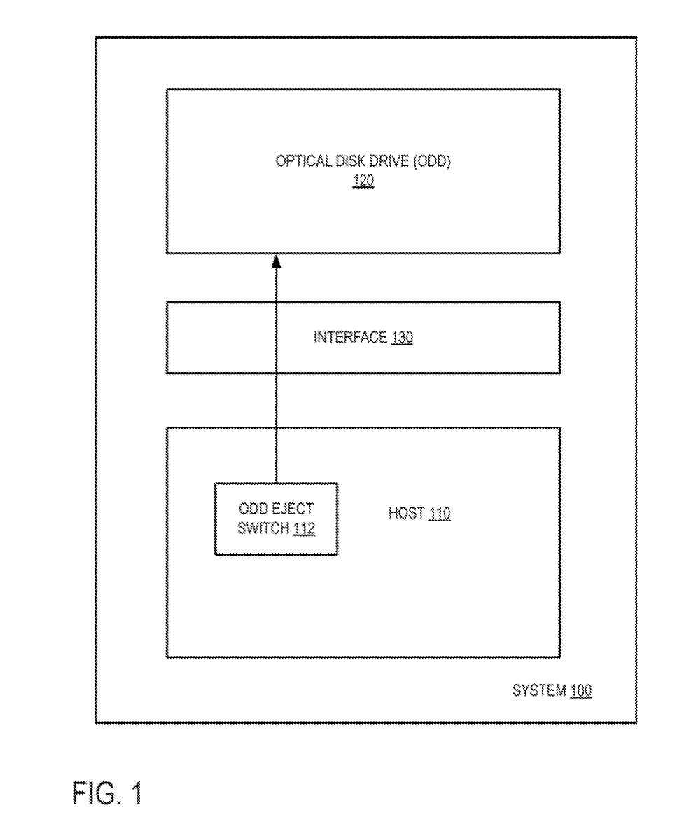

FIG. 1 is a block diagram illustrating a system according to various embodiments. System 100 illustrates a computer system having a host 110 that connects to an optical disk drive 120. While ODD 120 may be internal to system 100, as shown, it is not necessary that ODD 120 be an internal drive. In other words, ODD 120 could be an externally connected drive in certain embodiments. ODD 120 illustrates any suitable drive capable of receiving optical media including, but not limited to, tray-loading drives, slot loading drives and the like.

Interface 130 communicatively connects host 110 to ODD 120. Examples of suitable interfaces include, but are not limited to SATA (serial advanced technology attachment) buses, parallel ATA (PATA) buses, and other interfaces capable connecting a host (e.g., host bus adapter) to a mass storage device (e.g., hard disk drive, optical drive, etc.). In various embodiments, host 110 and ODD 120 are communicatively connected via a single pin on interface 130. For example, a SATA bus might connect host 110 and ODD 120 via the SATA Manufacturing Diagnostic pin. Other suitable pins and/or more pins could be used in different embodiments.

In various embodiments, an ODD eject switch 112 is located on the host side of interface 130. ODD eject switch 112 could be located on or integrated with host 110 or it could be communicatively connected with host 110. Interface 130 serves as a logical barrier between ODD eject switch 112 and ODD 120. In other words, any signal and/or communication from ODD eject switch 112 to ODD 120 passes through interface 130. By logically and/or physically locating ODD eject switch 112 on the host side of interface 130, power to ODD drive 120 (e.g., from interface 130) may be cut off when ODD drive 120 is not active (e.g., reading/playing optical media, etc.).

When power to ODD 120 is active, an assertion of ODD eject switch 112 triggers a media ejection mechanism of ODD 120 via interface 130. The media ejection mechanism could be a tray-loading mechanism, a slot-loading mechanism, or other suitable ejection mechanism.

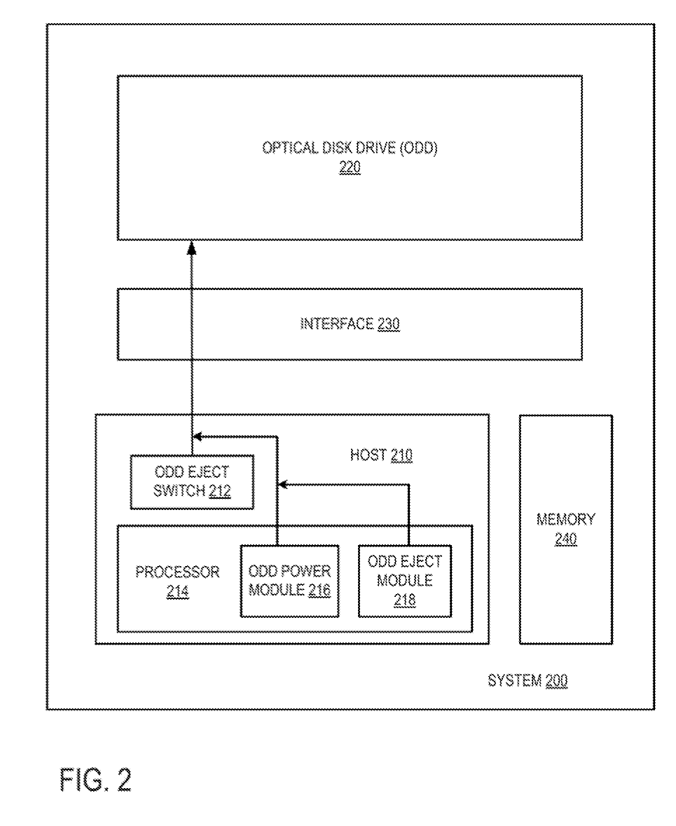

FIG. 2 is a block diagram of a system according to various embodiments. Similar to system 100, system 200 illustrates a computer system having a host 210 that connects to an optical disk drive 220. While ODD 220 may be internal to system 200, as shown, it is not necessary that ODD 220 be an internal drive. In other words, ODD 220 could be an externally connected drive in certain embodiments. ODD 220 can be any suitable drive capable of receiving optical media including, but not limited to, tray-loading drives, slot loading drives and the like.

Interface 230 communicatively connects host 210 to ODD 220. Examples of suitable interfaces include, but are not limited to SATA (serial advanced technology attachment) buses, parallel ATA (PATA) buses, and other interfaces capable connecting a host (e.g., host bus adapter) to a storage device (e.g., hard disk drive, optical drive, etc.). In various embodiments, host 210 and ODD 220 are communicatively connected via a single pin on interface 230. For example, a SATA bus might connect host 210 and ODD 220 via the SATA Manufacturing Diagnostic pin. Other suitable pins and/or more pins could be used in different embodiments.

In various embodiments, an ODD eject switch 212 is located on the host side of interface 230. ODD eject switch 212 could be located on or integrated with host 210 (as shown) or it could be communicatively connected with host 210 (e.g., external to host 210). By having a direct connection with host 210, ODD eject switch has power when host 210 has power.

Interface 230 acts as a logical barrier between ODD eject switch 212 and ODD 220. By logically and/or physically locating ODD eject switch 212 on the host side of interface 230, power to ODD drive 220 (e.g., from interface 230) may be cut off when ODD drive 220 is not active (e.g., reading/playing optical media, etc.).

When power to ODD 220 is active, an assertion (e.g., by a user) of ODD eject switch 212 triggers a media ejection mechanism of ODD 220 via interface 230. The media ejection mechanism on ODD 220 could be a tray-loading mechanism, a slot-loading mechanism, or other suitable ejection mechanism.

If ODD 220 is in a zero-power state (e.g., below a power threshold required for a minimum operational state), an assertion of ODD eject switch 212 triggers ODD power module 216 change the power state of ODD 220. In other words, an assertion of eject switch 212 causes ODD power module 216 to enable power to ODD 220. Once power is enabled to ODD 220, ODD eject module 218 sends a signal and/or software command to ODD 220 to trigger the eject mechanism on ODD 220, as described above. ODD eject module 218 may trigger the eject mechanism in direct response to detecting power enablement by ODD power module 216. Alternatively, ODD eject module 218 may trigger the eject mechanism on ODD 220 in response to detecting assertion of ODD eject switch 211 (e.g., perhaps by delaying the eject trigger signal/command for a period of time'to first allow ODD power module 216 to enable power to ODD 220).

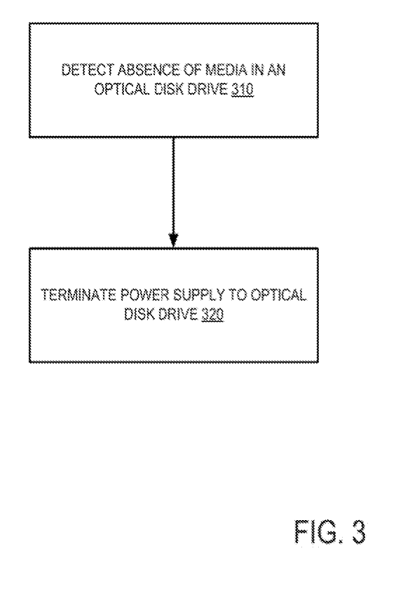

FIG. 3 is a flow diagram of operation in a system according to various embodiments. In various embodiments, a system detects 310 the absence of media in an optical disk drive. The optical disk drive may be internal to the system or it may be externally connected to the system. In response to detecting the absence of media, the system terminates 320 power supplied to the optical disk drive. In various embodiments, terminating power to the ODD reduces power consumption in the system.

In conventional systems, terminating power to the optical disk drive prevents the eject switch located on the optical disk drive from triggering a media ejection (e.g., ejecting a media tray). However, in the various embodiments describe herein, the ODD eject switch may be located on or directly connected to the host, allowing the host to detect assertion of the eject switch and re-establish power to the ODD for media ejection. By providing the flexibility to enable/disable power to the ODD, various embodiments are able to achieve power consumption savings for the system without sacrificing functionality of the optical disk drive.

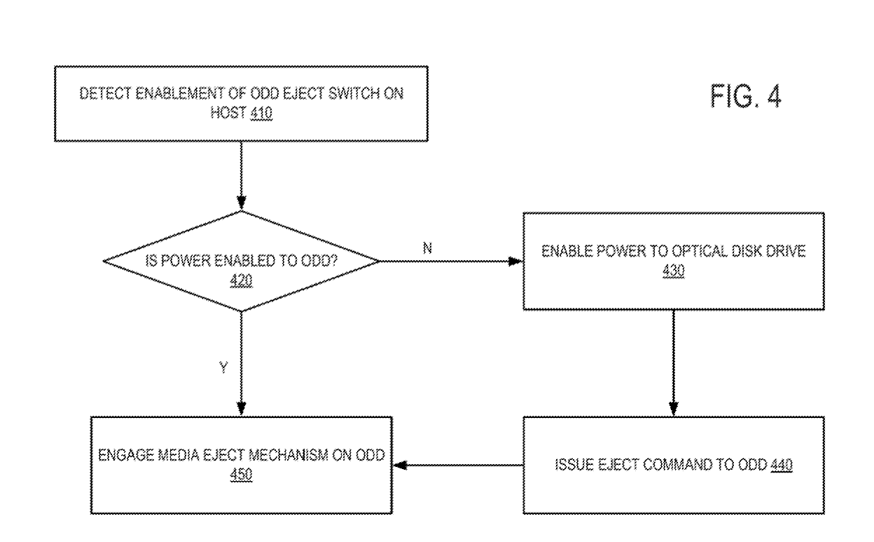

FIG. 4 is a flow diagram of operation in a system according to various embodiments. More steps, fewer steps, and/or different steps could be implemented in alternate embodiments. In addition, steps could be performed in a different order than described, in certain embodiments. As relates to FIG. 4, a system according to various embodiments may include an optical disk drive (ODD), a host, and an ODD eject switch. An interface (e.g., a SATA bus) may sit logically between the ODD and the combination of the host and ODD eject switch. The ODD eject switch may be integrated on or within the host or it may be logically connected to the host on the host-side of the interface.

In various embodiments, the system detects 410 enablement of the ODD eject switch, for example, at the host. The system then determines 420 whether power is enabled to the ODD. If power is enabled to the ODD, then enablement of the ODD eject switch causes the ODD to engage 450 a media eject mechanism on the ODD. If, however, power is not enabled to the ODD, then enablement of the ODD eject switch causes the system to enable 430 power to the optical disk drive. For example, an ODD power control module on the host could detect enablement of the ODD eject switch and, in response, enable power to the ODD. Once power is active to the ODD, the system issues 440 an eject command to the ODD. The eject command (e.g., a software command, a hardware signal, or the like) causes engagement of the media eject mechanism on the ODD. If there was no power to the ODD when the ODD eject switch was enabled, then the associated eject signal associated with that enablement will have been lost. This problem is overcome by issuing the eject command from the host once the power has been activated to the ODD.

Various modules described with respect to FIGS. 1-2 and/or various method steps described with respect to FIGS. 3-4 could be embodied by instructions on a computer-readable storage medium in certain embodiments. Such instructions could be stored in a memory such as, for example, memory 240 of FIG. 2 and executed by a processor such as, for example, processor 214 of FIG. 2.

1. A system, comprising:
a host computer;
an optical disk drive (ODD);
an interface to connect the ODD to the host computer; and
an ODD eject switch on the host computer to trigger a media ejection mechanism of the ODD via the interface.

2. The system of claim 1, wherein the host computer and the ODD are communicatively connected via a single pin on the interface.

3. The system of claim 1, further comprising:
an ODD power module on the host computer to control a power state of the ODD.

4. The system of claim 3, further comprising:
an ODD eject module to send an eject command to the ODD in response to a transition of the ODD from a zero-power state to a power-on state.

5. A method, comprising:
detecting an absence of media in an optical disk drive (ODD); and
terminating power to the ODD in response to detecting the absence of media.

6. The method of claim 5, wherein terminating power to the ODD further comprises:
terminating power to link detection circuitry between the ODD and a host computer.

7. The method of claim 5, further comprising:
restoring power to the ODD in response to enablement of an ODD eject switch logically located on the host side of an interface that is logically between the ODD and a host computer.

8. The method of claim 7, further comprising:
sending a tray eject signal from the host computer to the ODD subsequent to restoring power to the ODD.

9. A computer-readable storage medium containing instructions that, when executed, cause a computer to:
detect enablement of an eject switch associated with an optical disk drive (ODD), wherein the eject switch is separated from the ODD by an interface;
determine that power is not enabled to the ODD;
enable power to the ODD; and
issue an eject command to the ODD via the interface.

10. The computer-readable medium of claim 8, wherein the instructions that cause the determining of power not being enable to the ODD comprise further instructions that cause the computer to:
determine that power is not enabled to the interface, wherein the interface is a serial Advanced Technology Attachment (ATA) interface.

11. The computer-readable medium of claim 9, comprising further instructions that cause the computer to:
detect enablement of the eject switch while power is enable to the ODD; and
send an eject switch enablement signal to the ODD through the interface.
